(19) United States
(12) Patent Application Publication
(10) Pub. No.: US 2005/0217025 A1
(43) Pub. Date: Oct. 6, 2005

(54) Standing frame with lift, support and transport of user

(76) Inventor: Edward C. Barattia, Chicago, IL (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(21) Appl. No.: 11/076,350

(22) Filed: Mar. 9, 2005

Related U.S. Application Data
(60) Provisional application No. 60/558,034, filed on Mar. 31, 2004.

(51) Int. Cl. A61G 7/10

(52) U.S. Cl. 5/86.1; 5/81.1 R

(57) ABSTRACT

A standing frame to aid a person with inability to stand or walk to rise to a standing position and transfer from or to other locations such as chairs, toilets, beds. The standing frame has a flat rigid base with fixtures mounted to it that support a vertical rail frame. The vertical rail frame may be adjusted vertically and the frame incorporates a winch and pulley system that uses rope and a belt to lift a person to a standing position and lower the person to a sitting position. The vertical frame also provides handholds for the person being raised to steady himself. The base is preferably provided with roller balls to easily reposition the frame with a person aboard for relocating the person.

### RELATED APPLICATIONS

This application claims the benefit of U.S. Provisional Application Ser. No. 60/558,034, filed Mar. 31, 2004, and herein incorporated by reference.

### FIELD OF THE INVENTION

This invention relates in general to structures, systems, and procedures for the lifting, transfer, and transport of individuals requiring assistance and more particularly to a portable standing frame with electromechanical lifting means associated with an inexpensive, yet dependable, safe and easy way to operate with or without assistance and enables a person to be lifted, supported and transported to and from a sitting position.

### BACKGROUND OF THE INVENTION

Over the years past many standing-frames have been devised to assist a wheel chair bound or bed ridden person to stand. Such devices range from simple rail structures to more complex and even mechanized apparatus. Examples of the range of such prior art devices may be seen by reference to the following U.S. patents:

| Patent No. | Issue Date | Inventor | Title |
|---|---|---|---|
| 2,757,388 | Aug. 7, 1956 | Chisholm | Bedside Transfer Stand |
| 2,963,713 | Dec. 13, 1960 | Forrest | Invalid Transfer Apparatus |
| 2,975,435 | Mar. 21, 1961 | Forrest | Invalid Transfer Apparatus |
| 3,272,530 | Sep. 13, 1966 | Klassen | Carrier For Invalids |
| 3,911,509 | Oct. 14, 1995 | Fleckenstein | Patient Transfer Stand |
| 3,940,808 | Mar. 2, 1976 | Petrini | Patient Transfer Apparatus |
| 4,065,179 | Dec. 27, 1999 | Takasaki | Nursing Carriage |
| 4,157,593 | Jun. 12, 1979 | Kristensson | Patient Lift and Transport Apparatus |
| 4,279,043 | Jul. 21, 1981 | Saunders | Transfer Stand |
| 4,305,579 | Dec. 15, 1981 | Rice | Exercising Device |
| 4,829,612 | May 16, 1989 | Adams | Patient Transfer Apparatus |
| 4,934,003 | Jun. 19, 1990 | Hayakawa et al. | Device for Transferring the Disabled |
| 4,948,156 | Aug. 14. 1990 | Fortner | Standing Lift and Support for Wheelchair User |
| 4,981,307 | Jan. 1, 1991 | Walsh | Suspension Harness/Body Jacket Arrangement |
| 5,093,944 | Mar. 10. 1992 | Winston, Sr. | Patient Transfer Apparatus |
| 5,384,922 | Jan. 31, 1995 | Jobe | Foot Turn Table for Wheel Chair Patients |
| 5,524,303 | Jun. 11, 1996 | Palmer, Jr. et al. | Person Lifter/Rotator |
| 5,526,541 | Jun. 18, 1996 | Massey et al. | Patient Transfer Stand |
| 6,503,176 | Jan. 7, 2003 | Kuntz | Walker Device with Power Assisted Lift |

Among the foregoing patents, U.S. Pat. No. 4,948,156 includes a manually operated mechanical winch and a harness to lift an individual. U.S. Pat. No. 5,524,303 employs compressed air for a pneumatic lift; and U.S. Pat. No. 3,940,800 has an electric motor screw drive. Others have turn tables or are mounted on wheels to reposition the standing person after being lifted to the standing position for transfer of the person.

A commercial line of standing frames including motorized ones is available from a company called Stand Aid of Iowa, and their products may be found on the internet website.

Despite all the activity in this field, there still remains a need for an improved standing frame that is easy to transport, inexpensive, not cumbersome and safely and reliably lifts, supports, transports and allows for repositioning of the user.

Many of the devices currently available to assist with patient transfer do not have an adequate power assist feature. Those that do are not capable of allowing the patient's pants to be removed to allow for using the toilet or to dress or undress. This present standing frame can accommodate these tasks for some patients.

Another advantage of the present standing frame is that the relatively small size allows use in dwellings with narrow doors and tight spaces.

The preferred electric power winch allows a helper or caregiver with limited strength to assist a much larger person, and, of course, assistance is recommended when the person to be lifted and transferred is unable or incapable of solo operation.

### BRIEF SUMMARY OF THE INVENTION

The invention provides a standing frame that gives an opportunity for a person without an ability to stand without assistance (but with some amount of upper body strength and control) to be raised to a standing position, moved a short distance, and then seated at the nearby location. The base of the apparatus supports a removable vertical rail assembly. The base also holds a battery and charger to operate a power winch. The vertical part of the device supports a cushioned knee support and a power driven winch that feeds out and takes in rope through a pulley system. The rope is attached to a heavy-duty belt that is placed as low as possible on the backside of a seated person. As the winch takes in rope the knees of the seated person are pressed into the cushioned knee support and the pull of the winch then raises the person to an upright standing position. The entire apparatus, along with the standing individual, can be rotated or moved laterally a short distance.

### BRIEF DESCRIPTION OF THE DRAWINGS

FIG. 1 is a top right perspective view of a standing frame according to my invention showing the relative positioning of the principal structural components of the standing frame;

FIG. 2 is a partial side view of the major components of the standing frame. The topmost part is not completely represented, and the wiring for the battery, winch, and winch control are not included;

FIG. 3 is a top view of the base of the standing frame taken along the line 3-3 in FIG. 2 (excluding the vertical components for clarity);

FIG. 4 is a side and front view of the structural component of the central vertical component;

FIG. 5 is a view of a top handle that slip fits into the central vertical component. The overall height of the top handle can be adjusted with a pin that protrudes through the slip fit pieces;

FIG. 6 is a top plan view taken along the line 6-6 in FIG. 2, with components removed;

FIG. 7 is a partial perspective view of an alternative form for pivoting the base with respect to the frame;

FIG. 8 is a top right perspective view of an alternative form of the stranding frame;

FIG. 9 is a side view of the base portion of the standing frame in FIG. 8;

FIG. 10 is a top view of the base portion in FIG. 9;

FIG. 11 is a side and front view of the upright frame portion of FIG. 8;

FIG. 12 is a partial top right perspective view and partially fragmented of another alternative form of the standing frame here showing a removable cover and support for the battery and charger arrangement;

FIG. 13 is a partial perspective view similar to FIG. 12 showing the cover and support in a closed position; and

FIG. 14 is a perspective view of the components of FIGS. 12 and 13 partially disassembled.

### DETAILED DESCRIPTION OF THE INVENTION

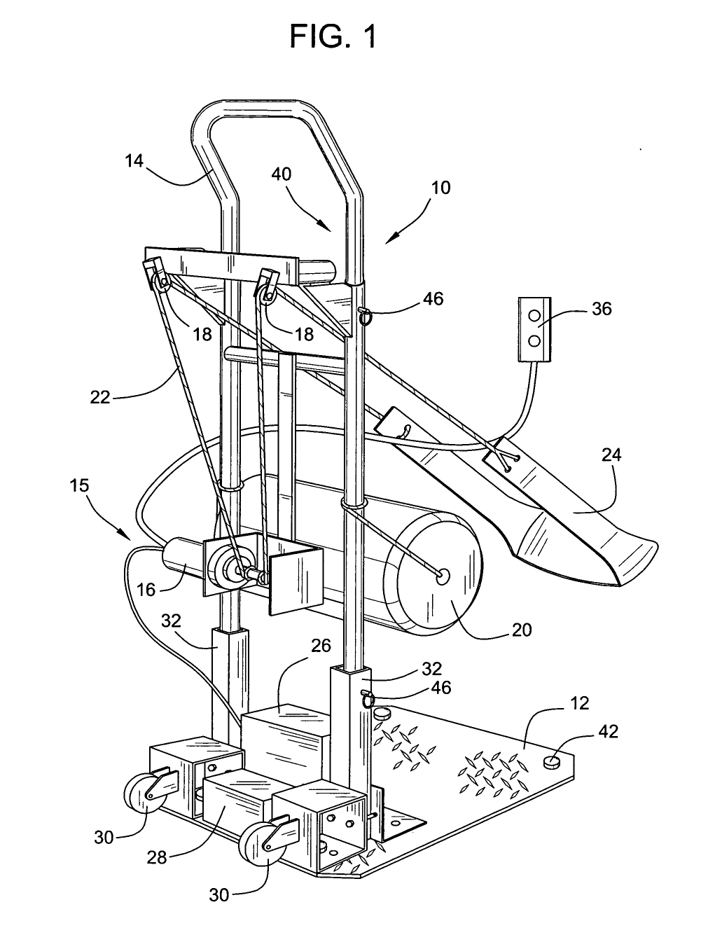

Referring to the drawings, there is shown in FIG. 1, a standing frame 10 in accordance with a preferred embodiment of the present invention. The frame 10 in general is made up of a base 12, upright rail structure 14, and components 15 attachable to the base and rail structure including, electric power winch 16, pulleys 18, knee support cushion 20, rope 22 and a belt or harness 24. Also, there is preferably provided a battery 26, a charger 28, and wheels 30 to move the frame around without a person aboard.

The vertical rail structure 14 is preferably removable by way of fixtures 32 mounted to the base 12. The base 12 when removed can be collapsed upwardly for storage and it may be made of aluminum tread plate stock. The vertical rail can be adjusted upwardly and downwardly according to the size of the person using the frame.

The winch 16 is preferably a unit with a 12 volt D.C. motor and winding reel that receives high tensile strength, low stretch ropes that provide sufficient tensile strength and flexibility to lift and lower a person safely and reliably such as, for example, Samson Ultra Tech line which is a double braid polyester and Technora core line. A hand held operating switch pig-tail module 36 with wire attachment may be used for easy operation by either the person being lifted or by an assistant.

In accordance with a feature of the invention, the knee support cushion 20 is a tubular inflatable structure such as ones used for a boat fender. By way of selective inflation the cushion 20 provides both cushioning and lateral support.

In order to lift and lower a person by way of the power winch 16 that takes in and feeds out rope, there is provided a heavy-duty belt or harness 24. The belt is preferably made of leather or a like material that has flexibility and strength yet it can be contoured to position or fit the person and enable clothing to be removed. Also, the belt has to be easily and readily cleaned. To that end, disposable or launderable covers (not shown) may be applied to the belt with easy attachment and removal arrangements common in the covering art.

The vertical rail structure is provided with areas for hand holds 40 in order for the person to steady himself or herself while being lifted or lowered.

Another feature of the present invention is the provision of ball rollers 42 which are preferably added to the underside of base 12. The ball rollers which are available as a unit provide the ability of the standing frame to be rotated or repositioned with a person aboard so that the person may be transferred to or from one facility to another.

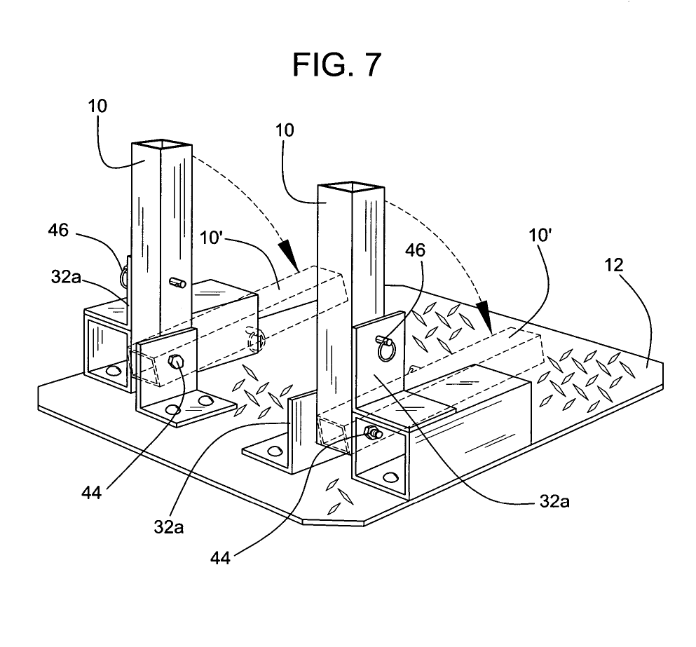

Referring to FIG. 7, there is shown an alternative form for allowing the base 12 to be pivoted with respect to the vertical frame 10. In the present instance fixtures 32a are open sided and frame 10 connects to the fixtures with bolts 44. Spring pins 46 are used to lock the pivoted base either upright or in a collapsed position.

The following examples further illustrate the invention but, of course, should not be construed as in any way limiting its scope.

### EXAMPLE 1

Recently, my father lost his ability to walk. He was able to stand himself upright by holding on to grab bars mounted to walls.

It was not always possible to have a grab bar in front of him to allow him to stand. For those situations I modified a two-wheel hand truck (dolly) by fastening a larger floor plate that he could stand on while pulling himself into a standing position. Months later he was unable to maintain a standing position because his knees would buckle. I made a further modification to the hand truck that placed a padded bar in front of his knees to prevent his knees from buckling.

Within 3 months, he was unable to pull himself into a standing position without substantial assistance from a helper to lift him with a gait belt while he tried to stand. This became too difficult for the helper or care giver, so I made another modification to the hand truck by placing a 12 volt D.C. winch with a rope and pulley system attached to a heavy belt. With the belt placed as far down as possible behind his backside, the winch raised him to a standing position with, only a modest effort to hold the body upright.

Hand trucks, or dollies, are made to lift heavy objects by pivoting the center of gravity up and back over the axle. This is just the opposite of how weight is applied to the standing frame. The weight of the individual being pulled into a standing position is centered in front of the axle, and has a tendency to tip the hand truck over and places a lot of stress on the weld holding the floor plate to the vertical part of the frame.

Subsequently I designed and built a standing frame to better support weight that is centered in front of the vertical part of the frame. It also allows the vertical part to be removed from the floor plate so the standing frame can be more easily transported in two parts in a vehicle.

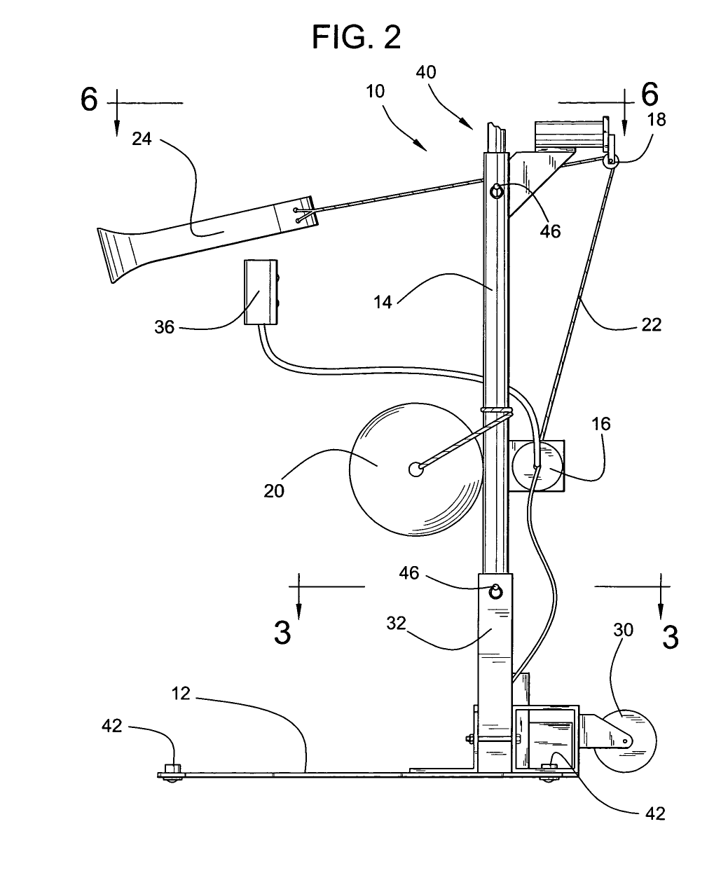

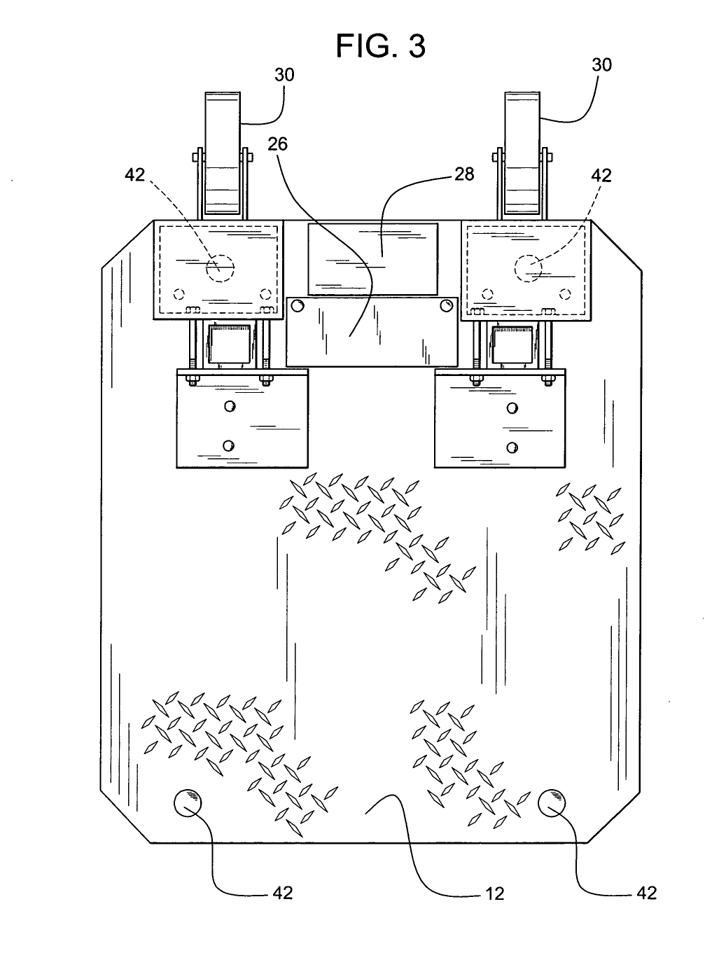

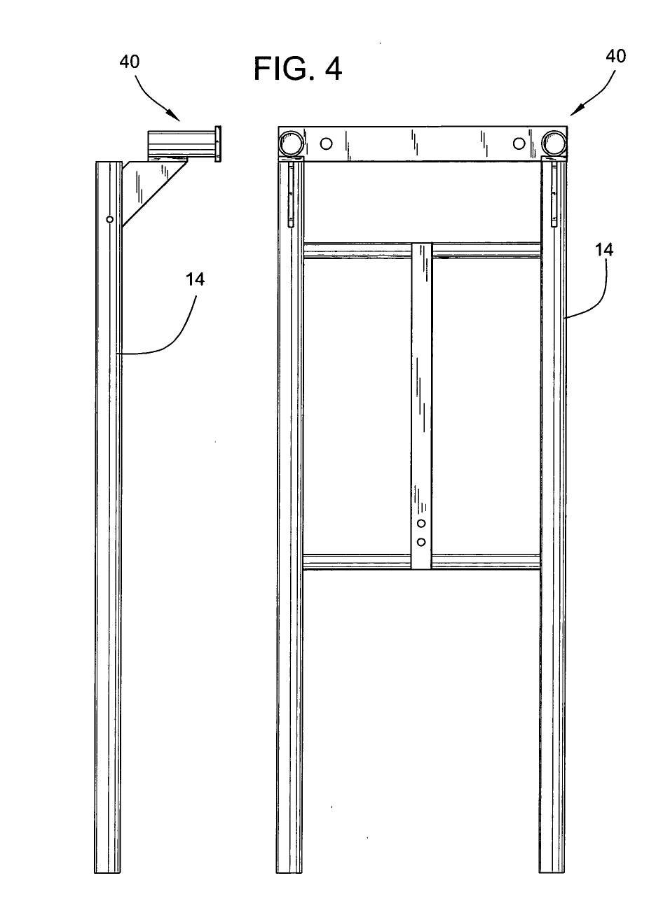

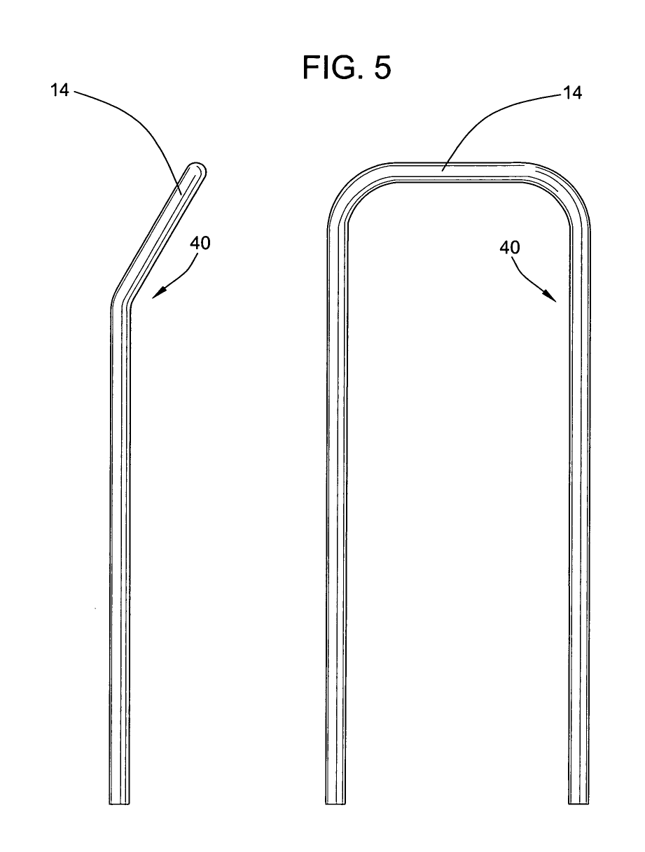

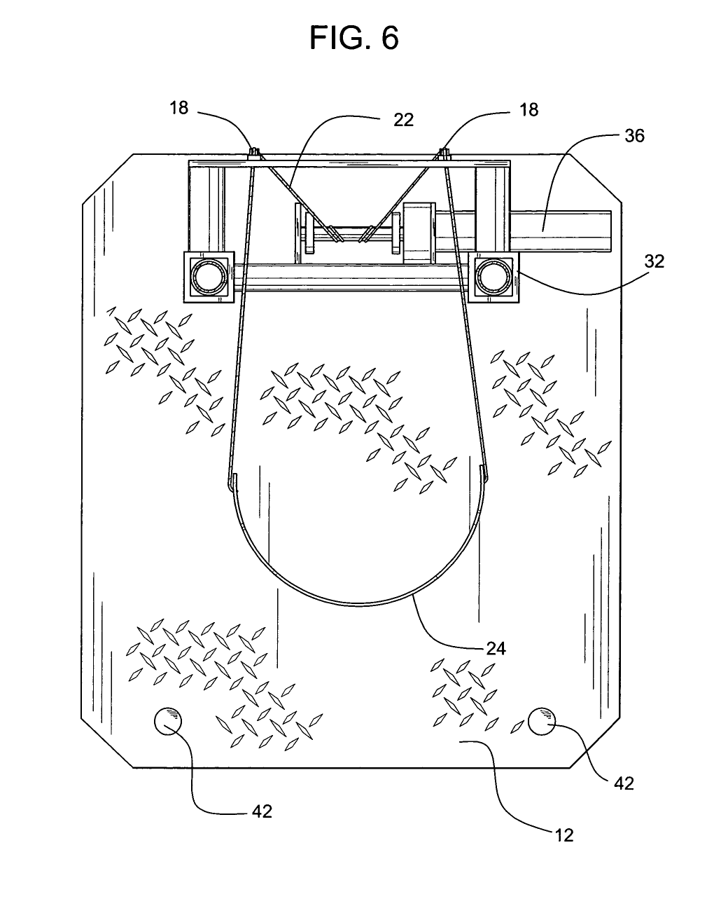

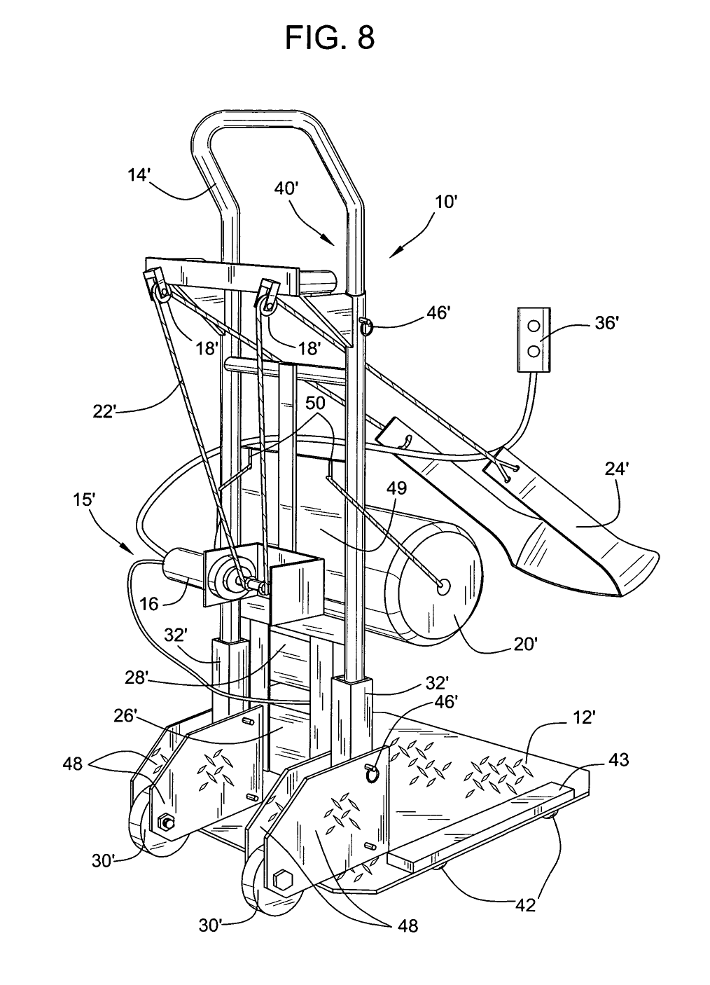

Referring to FIG. 8, there is shown an alternative form of the standing frame. The components that are essentially the same have been given the same reference numerals as in FIGS. 1-7 with the “prime” addition. In the present instance, the base 12 has been given reinforcement channels 43 that cover the ball rollers 42′ and the battery 26′ and charger 28′ have been moved onto the upright rail structure 14′. Speed plates 48, support the wheels 30′.

In addition, a plate 49 has been affixed to the upright rail 14′ and notches 50 added to provide adjustable securement of the knee cushion 20′ support lines.

The upright frame 10′ may be removed as well as the battery and charger so separate lighter weight components along with the base may be transported.

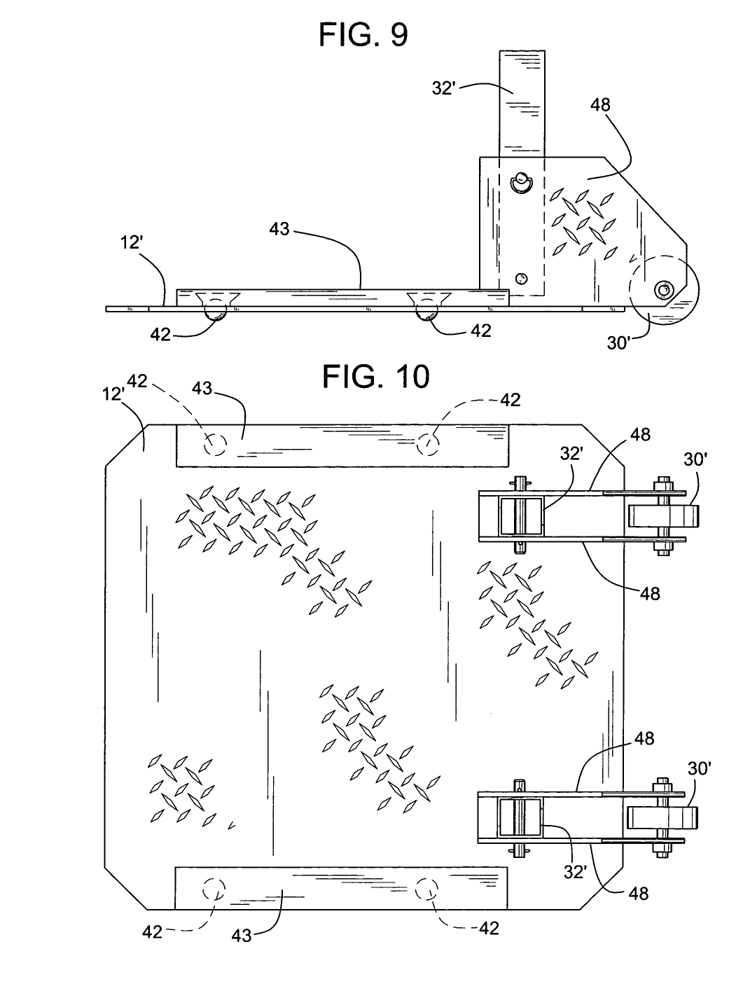

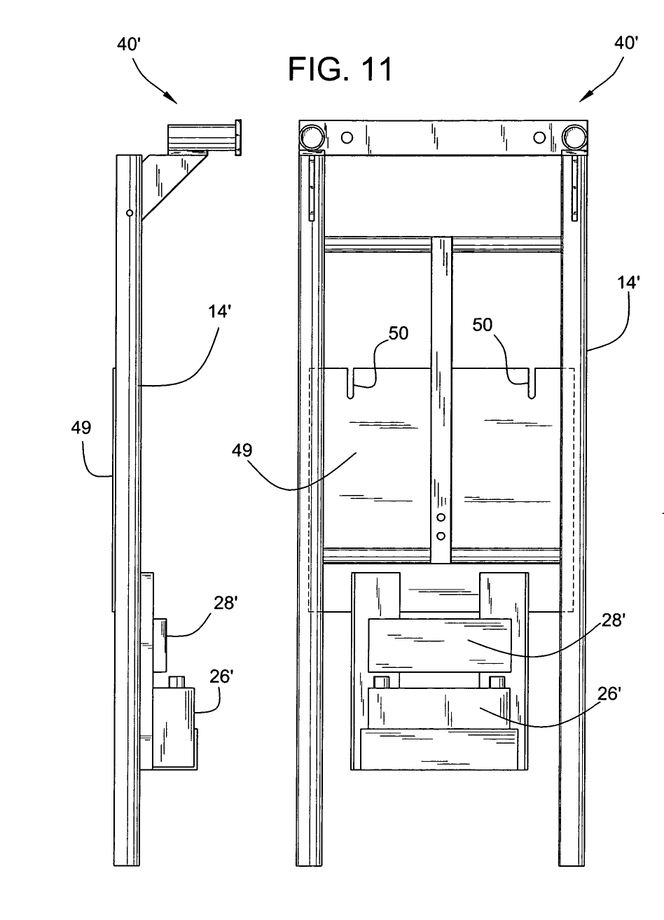

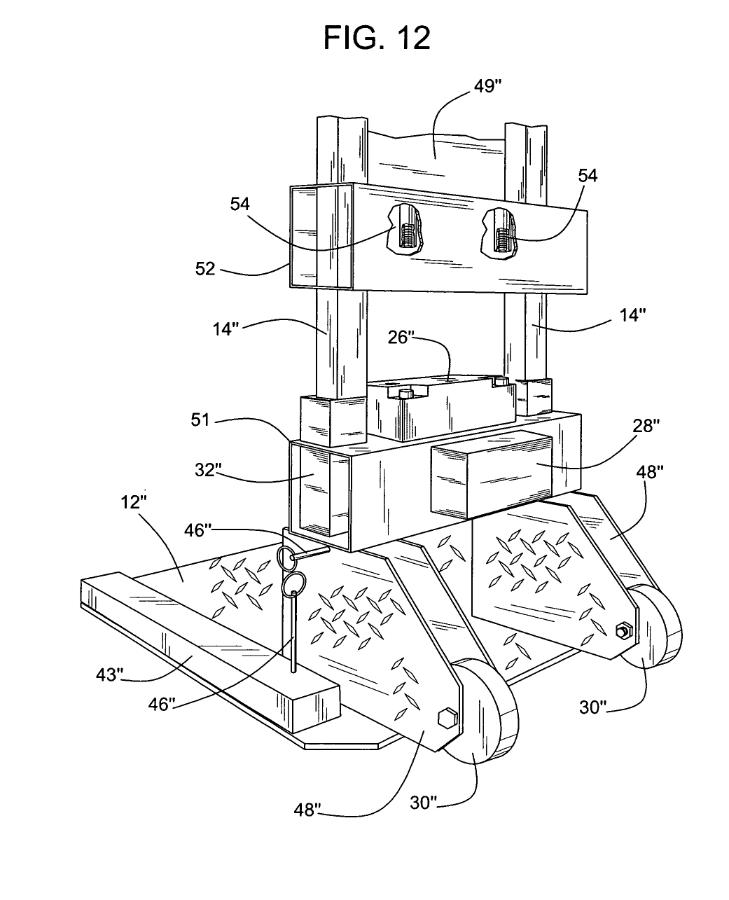

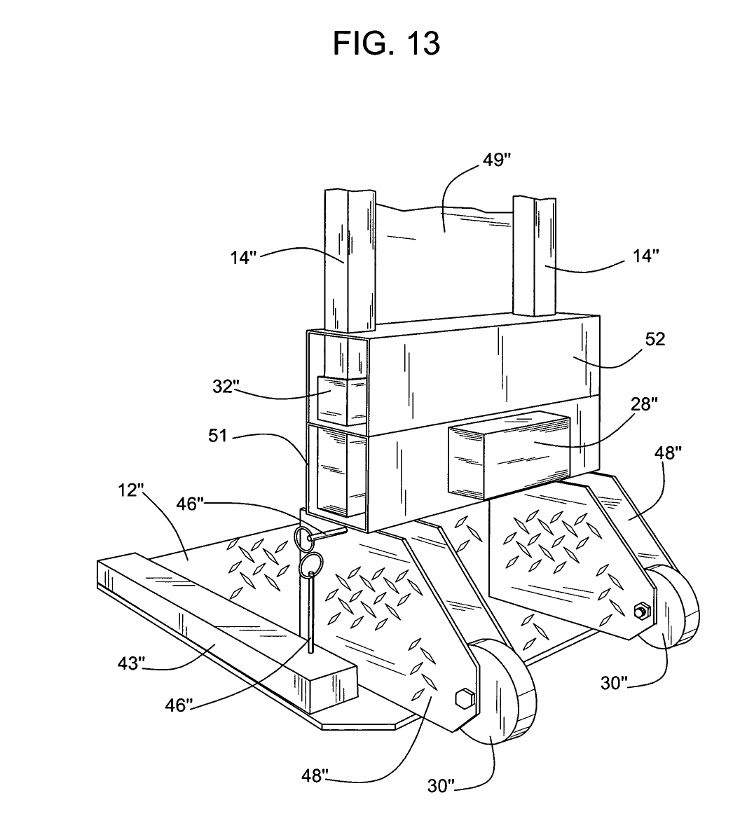

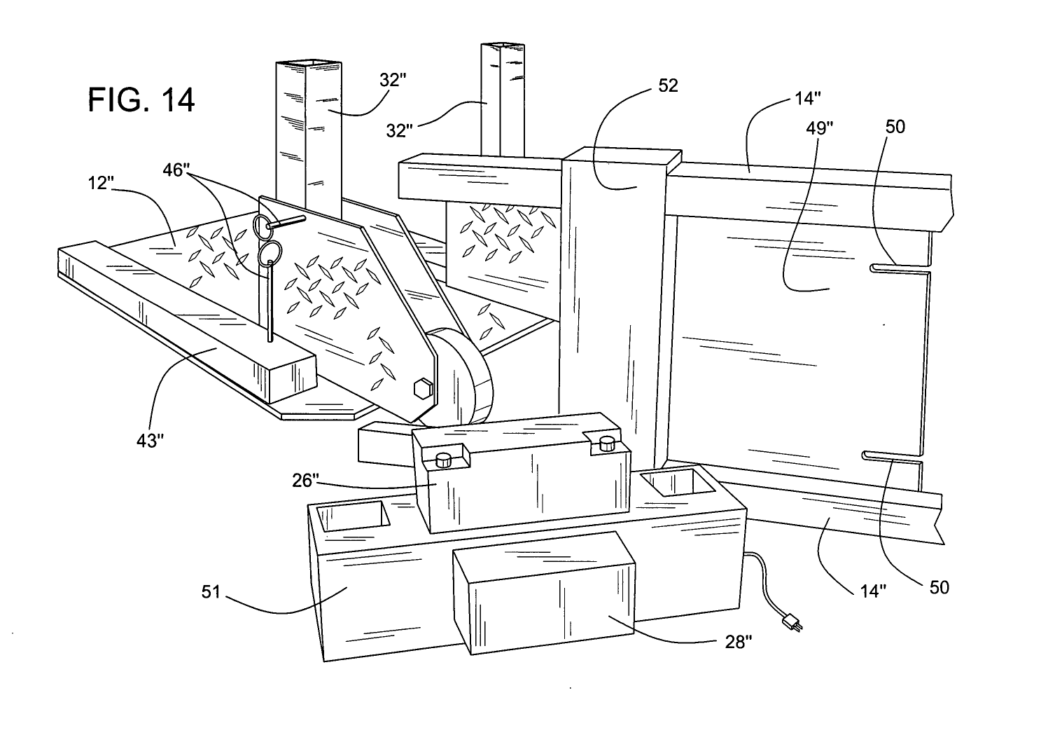

Referring to FIGS. 12-13, there is shown another alternative form of the standing frame. Here a double prime ″ is used for the reference numerals that are essentially the same components as in FIGS. 1-11. In the present instance, a first or lower rectangular tube shaped member 51 slides onto the upright rail 32″. The charger 28″ attaches to member 51 and the battery 26″ rests on member 51.

A second or upper rectangular tube shaped member 52 slides on the rails 14″ and forms a cover for the battery 26″ when in place as shown in FIG. 13. This provides a more modular arrangement that may be taken apart without tools and a more aesthetic look to the standing frame.

The lower member 51 provides a support function and the upper member 52 functions as a cover. That can be reversed or mixed as may be desired. The member 51 carries spring contacts 54 to connect to the battery when in place. Upper rails 14″ are rectangular and may be lightweight aluminum or similar material. Quick release spring pins 46″ are used where applied to secure parts without need for tools to assemble or disassemble the standing frame. By providing modules or separable components the standing frame can be broken down into lesser weight and sized pieces for easier transportation and handling.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A standing frame for helping a person, not able to walk or stand without aid, to rise from a seated position and return to a seated position at the same or different location, comprising, in combination, a horizontal base, a upright rail means attachable to said base, an electric motor powered winch means carried by said rail means, rope and pulley means carried by the rail means with the rope having a first end portion connected to said winch for taking in and feeding out said rope, a belt means, the second end portion of said rope being affixed to said belt means adapted to fit said person, and motor control means for reversibly operating said motor and winch means for raising and lowering said person.

2. A standing frame as claimed in claim 1, wherein said rope means has a pair of spread apart second end portions and pulleys, and the respective second end portions attach to said belt means.

3. A standing frame as claimed in claim 1, wherein said rail means is vertically adjustable.

4. A standing frame as claimed in claim 1, wherein said rail means is collapsible.

5. A standing frame as claimed in claim 1, wherein said rail means has handholds.

6. A standing frame as claimed in claim 1, wherein said base includes wheels for tilting the frame and moving the standing frame assembly.

7. A standing frame as claimed in claim 1, wherein said base has casters to move the entire frame rotationally and horizontally.

8. A standing frame as claimed in claim 7, wherein said casters are ball casters.

9. A standing frame as claimed in claim 1, wherein said motor is battery powered and the frame carries a rechargeable battery source.

10. A standing frame as claimed in claim 1, wherein said upright rail means carries cushioned knee support means for the person being assisted.

11. A standing frame as claimed in claim 9, wherein said knee support means is inflatable for lateral support.

12. A standing frame as claimed in claim 1, wherein said motor control is a handheld pigtail switch module.

13. A standing frame as claimed in claim 9, wherein the components comprising the base, upright rail means, rechargeable battery source are individual modules and assemblable without tools.
